(19) United States
(12) Patent Application Publication
(10) Pub. No.: US 2026/0249679 A1
(43) Pub. Date: Aug. 27, 2026

(54) UNIVERSAL FITTING ANTI SIPHON DEVICE

(71) Applicants: Robert Joseph Ponticelli, SR., Green Valley, AZ (US); Robert Joseph Ponticelli, JR., Green Valley, AZ (US)

(72) Inventors: Robert Joseph Ponticelli, SR., Green Valley, AZ (US); Robert Joseph Ponticelli, JR., Green Valley, AZ (US)

(21) Appl. No.: 19/548,763

(22) Filed: Feb. 24, 2026

Related U.S. Application Data
(60) Provisional application No. 63/834,148, filed on Feb. 24, 2025.

(51) Int. Cl. B60K 15/04

(52) U.S. Cl. CPC B60K 15/0403

(57) ABSTRACT

An anti-siphon device configured to fit and attach to a container filler neck comprises an upper cylindrical member and a lower cylindrical member secured by upper and lower retaining rings. The upper cylindrical member includes a hollow interior, an O-ring annular groove, upper and lower annular grooves, a flange, and screw tapped holes. The lower cylindrical member includes a sidewall with apertures permitting fluid passage and a support segment configured to fit between the retaining rings. A custom-fitting neck adaptor enables installation in various container configurations, secured via set screws, spring-loaded latches with vertical attachment tabs, longitudinal slots engaging container neck protrusions, or adhesive elements. The device may incorporate an O-ring for sealing, a wave spring for shock absorption, a rubber damper to prevent tube insertion, chain mail or metal construction for the lower member, and chemically resistant adhesive for enhanced attachment strength. The device prevents siphon tube insertion while permitting normal fuel filling operations.

### (B) CROSS-REFERENCE TO RELATED APPLICATIONS

This application claims priority to and the benefit of U.S. Provisional Patent Application No. 63/834,148, filed on Feb. 24, 2025, the entire disclosure of which is incorporated herein by reference.

### (C) STATEMENT REGARDING FEDERALLY SPONSORED R & D

Not Applicable

### (D) THE NAMES OF THE PARTIES TO A JOINT RESEARCH AGREEMENT

Not Applicable

### (E) REFERENCE TO A “SEQUENCE LISTING,” A TABLE, OR A COMPUTER PROGRAM

Not Applicable

### (F) STATEMENT REGARDING PRIOR DISCLOSURES BY AN INVENTORS

Not Applicable

### (G) BRIEF DESCRIPTION OF THE INVENTION

The present invention relates to an anti-siphon device (100) configured to prevent unauthorized fuel theft from vehicles and storage containers. The device comprises an upper cylindrical member (200) and a lower cylindrical member (300) secured together by upper retaining rings (510) and lower retaining rings (520), creating a barrier that prevents siphon tube insertion while permitting normal fuel filling operations.

The upper cylindrical member (200) includes specialized annular grooves for retaining rings, an O-ring annular groove (241) for sealing, screw tapped holes (260) for attachment, and an outward-extending flange (250). The lower cylindrical member (300) features a sidewall (330) with multiple apertures (336) that permit fluid passage and a support segment (340) that is captured between the retaining rings (510, 520). The sidewall (330) of the lower cylindrical member (300) may be constructed from chain mail (332) or metal (334) formed by stamping, machining, or die-casting processes.

For installation in containers with varying filler neck sizes and configurations, the device includes a custom-fitting neck adaptor (400) that provides a universal interface. The custom-fitting neck adaptor (400) may be secured using multiple attachment mechanisms including set screws (270), screws (480), spring-loaded latches (490) with vertical attachment tabs (460), longitudinal slots (455) engaging with container neck protrusions, or chemically resistant adhesive elements (550).

Additional features include O-ring sealing to prevent bypass gaps, a wave spring for shock absorption during tampering attempts, and a rubber damper to eliminate insertion spaces. The modular design enables a single standardized anti-siphon device core to be adapted to virtually any filler neck configuration through selection of the appropriate custom-fitting adaptor, providing universal compatibility across diverse vehicle platforms and fuel container types.

### (H) BRIEF DESCRIPTION OF THE SEVERAL VIEWS OF THE DRAWING

FIG. 1 is an isometric view of an assembled anti-siphon device (100), showing the upper cylindrical member (200) and the lower cylindrical member (300);

FIG. 2 is an exploded view of the anti-siphon device (100) configured to fit the most popular sized container filler necks (92), showing the upper cylindrical member (200) and the lower cylindrical member (300), where the sidewall (330) of lower cylindrical member (300) is made of chain mail (332). The stacking order of this embodiment is: an upper retaining ring (510), a lower cylindrical member (300), a wave spring (540), an upper cylindrical member (200), a lower retainer ring (520), plurality of screw tapped holes (260) and a plurality of set screws (270) within the upper cylindrical member (200), and an O-ring (530);

FIG. 3 is an exploded view of the anti-siphon device (100), showing the upper cylindrical member (200) and the lower cylindrical member (300) and utilizing a custom-fitting neck adaptor (400). The stacking order of this embodiment is: an upper retaining ring (510), a lower cylindrical member (300), a wave spring (540), an upper cylindrical member (200), a lower retainer ring (520), plurality of screw tapped holes (260) within the upper cylindrical member (200), a custom-fitting neck adaptor (400), a plurality of screw tapped holes (450) and a plurality of set screws (270) within the custom-fitting neck adaptor (400), and an O-ring (530);

FIG. 4 is an exploded view of the anti-siphon device (100), showing the upper cylindrical member (200) and the lower cylindrical member (300) and utilizing a custom-fitting neck adaptor (400) in a spring-loaded latch attachment embodiment. The stacking order of this embodiment is: an upper retaining ring (510), a lower cylindrical member (300), a wave spring (540), an upper cylindrical member (200), a lower retainer ring (520), a plurality of screw tapped holes (260) within the upper cylindrical member (200), a custom-fitting neck adaptor (400) in a spring-loaded latch attachment embodiment with a plurality of spring-loaded latches (490), and a double sided adhesive element (550);

FIG. 5 is an exploded view of the anti-siphon device (100), showing the upper cylindrical member (200) and the lower cylindrical member (300) and utilizing a custom-fitting neck adaptor (400). The stacking order of this embodiment is: an upper retaining ring (510), a lower cylindrical member (300), a wave spring (540), an upper cylindrical member (200), a lower retainer ring (520), plurality of screw tapped holes (260) within the upper cylindrical member (200), a custom-fitting neck adaptor (400), a plurality of screw tapped holes (450) and a plurality of set screws (270) within the custom-fitting neck adaptor (400), and an O-ring (530);

FIG. 6 is an exploded view of the anti-siphon device (100), showing the upper cylindrical member (200) and the lower cylindrical member (300) and utilizing a custom-fitting neck adaptor (400) in a spring-loaded latch attachment embodiment. The stacking order of this embodiment is: an upper retaining ring (510), a lower cylindrical member (300), a wave spring (540), an upper cylindrical member (200), a lower retainer ring (520), a rubber damper (560), a plurality of screw tapped holes (260) within the upper cylindrical member (200), a custom-fitting neck adaptor (400) in a spring-loaded latch attachment embodiment with a plurality of spring-loaded latches (490) and a plurality of longitudinal slots (455) extending from the upper open end toward the lower open end of the sidewall, and a double-sided adhesive element (550);

FIG. 7 is an exploded view of the anti-siphon device (100) configured to fit the most popular sized container filler necks (92), showing the upper cylindrical member (200) and the lower cylindrical member (300), where the sidewall (330) of lower cylindrical member (300) is made of metal (334). The stacking order of this embodiment is: an upper retaining ring (510), a lower cylindrical member (300), a wave spring (540), an upper cylindrical member (200), a lower retainer ring (520), plurality of screw tapped holes (260) and a plurality of set screws (270) within the upper cylindrical member (200), and an O-ring (530);

FIG. 8 is a perspective view of an embodiment of the custom-fitting neck adaptor (400);

FIG. 9 is a perspective view of an embodiment of the custom-fitting neck adaptor (400);

FIG. 10 is a perspective view of an embodiment of the custom-fitting neck adaptor (400) in a spring-loaded latch attachment embodiment, where the sidewall (420) comprises a plurality of spring-loaded latches (490);

FIG. 11 is a perspective view of an embodiment of the custom-fitting neck adaptor (400) in a spring-loaded latch attachment embodiment, where the sidewall (420) comprises a plurality of spring-loaded latches (490) and a plurality of longitudinal slots (455);

FIG. 12 is a cutaway view taken along line 12-12 of FIG. 1 showing the lower cylindrical member (300) inserted into the upper cylindrical member (200), where the support segment (340) of the lower cylindrical member (300) is located between the upper retaining ring (510) and the wave spring (540) and the lower retaining ring (520);

FIG. 13 is a perspective view of an assembled view of the anti-siphon device (100), showing the upper cylindrical member (200) and the lower cylindrical member (300) and utilizing a custom fitting neck adaptor (400) in a spring-loaded latch attachment embodiment. The anti-siphon device (100) is inserted through the container filler neck (92) of the container;

FIG. 14 is a sectional view along the mid-line of a 2.5 inch, threaded-type container filler neck (92) of the container (90), revealing a 2.5-inch custom-fitting neck adaptor (400) in a spring-loaded latch attachment embodiment attached thereto where the perimeter of the container filler neck (92) is welded to the container (90);

FIG. 15 is a sectional view along the mid-line of a 4.0 inch, threaded-type container filler neck (92) of the container (90), revealing a 4.0-inch custom-fitting neck adaptor (400) in a spring-loaded latch attachment embodiment attached thereto where the perimeter of the container filler neck (92) is welded to the container (90).

| Number | Element Name |
|---|---|
| 90 | Container |
| 92 | Container filler neck |
| 100 | Anti-siphon device |
| 200 | Upper cylindrical member |
| 210 | Hollow interior |
| 220 | Open upper end |
| 230 | Open lower end |
| 240 | Sidewall |
| 241 | O-ring annular groove |
| 242 | Inner surface |
| 244 | Upper annular groove |
| 246 | Lower annular groove |
| 248 | Outer surface |
| 250 | Flange |
| 260 | Plurality of screw tapped holes |
| 270 | Plurality of set screws |
| 300 | Lower cylindrical member |
| 310 | Hollow interior |
| 320 | Open upper end |
| 330 | Sidewall |
| 332 | Chain mail |
| 333 | Interlocking rings |
| 334 | Metal |
| 336 | Apertures |
| 340 | Support segment |
| 342 | Support ring |
| 344 | Flange |
| 400 | custom-fitting neck adaptor |
| 410 | Hollow interior |
| 420 | Sidewall |
| 425 | O-ring annular groove |
| 430 | Upper open end |
| 435 | Lower open end |
| 440 | Outward-Extending Flange |
| 445 | Inward-Extending Flange |
| 450 | Plurality of screw tapped holes |
| 455 | Plurality of longitudinal slots |
| 460 | Vertical attachment tabs |
| 470 | Aperture |
| 480 | Plurality of Screws |
| 490 | Plurality of spring-loaded latches |
| 510 | Upper retaining ring |
| 520 | Lower retaining ring |
| 530 | O-ring |
| 540 | Wave spring |
| 550 | Double sided adhesive element |
| 560 | Rubber damper |

### (I) BACKGROUND OF INVENTION

### (I) 1 Field of the Invention

The present invention relates generally to anti-theft devices for vehicles and storage containers, and more particularly to devices for preventing unauthorized fuel theft from commercial trucks and other automobiles.

### (I) 2 Description of the Related Art

Fuel theft through siphoning represents a significant problem for vehicle owners, fleet operators, and businesses maintaining fuel storage containers. Traditional siphoning involves inserting a tube into a fuel tank or container through the filler neck and using gravity or suction to extract the liquid fuel. Such theft not only results in direct financial loss but also poses safety and environmental hazards.

Previous attempts to prevent fuel siphoning have included various mechanical barriers and locking caps. However, many existing solutions suffer from drawbacks including difficulty of installation, incompatibility with different container types, vulnerability to forceful penetration, and interference with normal filling operations.

There exists a need for an anti-siphon device that can be readily installed in various container filler necks, provides robust protection against siphoning attempts, withstands forceful tampering, and allows normal fuel filling while preventing unauthorized extraction.

### (J) SUMMARY DESCRIPTION OF THE INVENTION

The present invention provides an anti-siphon device (100) that addresses the aforementioned needs. The anti-siphon device (100) is configured to fit and attach to a container filler neck (92) of a container (90) and comprises an upper cylindrical member (200) and a lower cylindrical member (300). The anti-siphon device (100) may further comprise a custom-fitting neck adaptor (400).

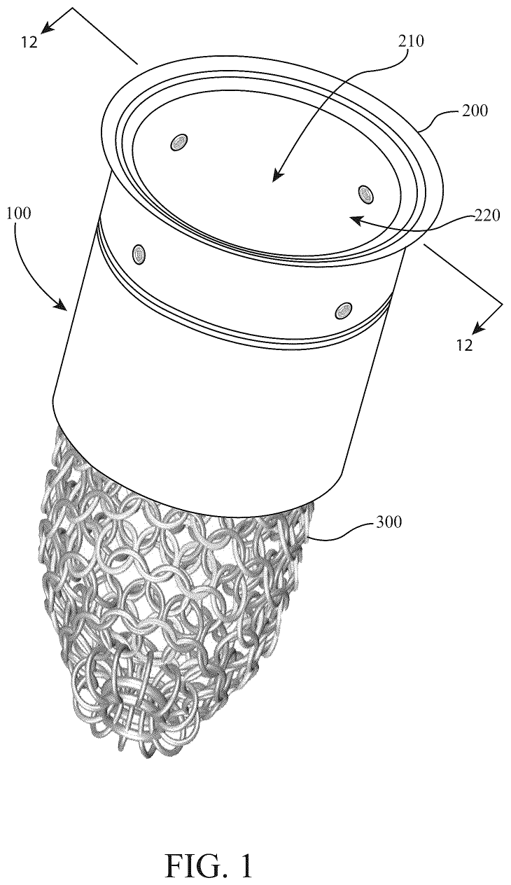

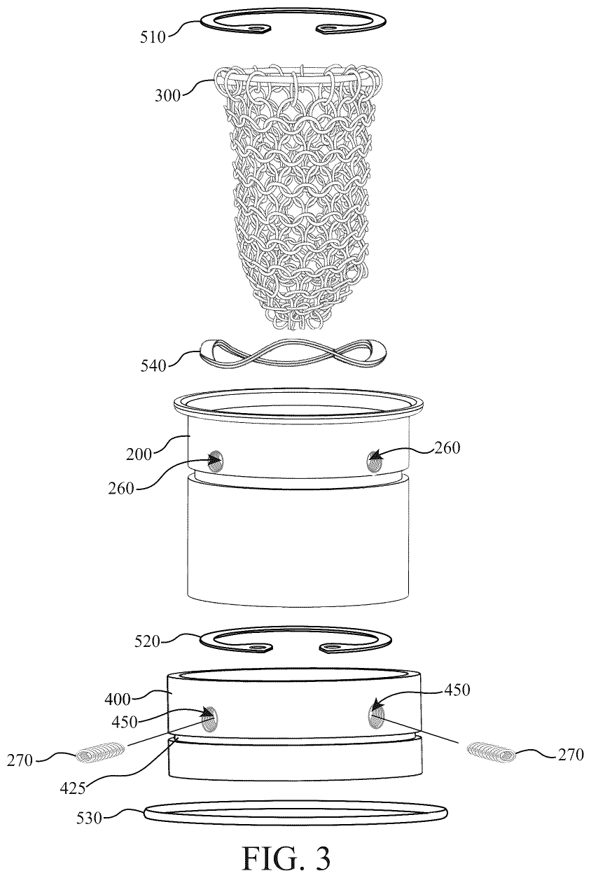

FIG. 1 is an isometric view of an assembled anti-siphon device (100), showing the upper cylindrical member (200) and the lower cylindrical member (300). FIG. 3 is an exploded view of the anti-siphon device (100), showing the upper cylindrical member (200) and the lower cylindrical member (300) and utilizing a custom-fitting neck adaptor (400).

In one aspect, the invention provides an anti-siphon device comprising an upper cylindrical member with specialized grooves and a flange, a lower cylindrical member with fluid permeable apertures, and upper and lower retaining rings that secure the assembly while creating a barrier against siphoning attempts.

In another aspect, the device includes a custom-fitting neck adaptor (400) that allows the anti-siphon device (100) to be installed in containers with varying filler neck dimensions and configurations.

Various embodiments provide different attachment mechanisms, including set screws, spring-loaded latches with vertical attachment tabs, and adhesive elements for enhanced security.

Additional features include O-ring sealing to prevent movement and seal gaps, wave springs for shock absorption, and various construction materials including chain mail and stamped metal for the lower cylindrical member.

### (K) Definitions

“Chain mail”—interlocking metal rings that create a flexible mesh structure with apertures between the rings

### (L) DETAILED DESCRIPTION OF THE INVENTION

### (L) 1 General Description

The anti-siphon device (100) is an anti-fuel theft device for vehicles and storage containers, and more particularly to devices for preventing unauthorized fuel theft from commercial trucks and other automobiles

The anti-siphon device (100) is configured to fit and attach to a container filler neck (92) of a container (90). The anti-siphon device (100) comprises an upper cylindrical member (200) and a lower cylindrical member (300). The anti-siphon device (100) may further comprise a custom-fitting neck adaptor (400).

FIG. 1 is an isometric view of an assembled anti-siphon device (100), showing the upper cylindrical member (200) and the lower cylindrical member (300). FIG. 3 is an exploded view of the anti-siphon device (100), showing the upper cylindrical member (200) and the lower cylindrical member (300) and utilizing a custom-fitting neck adaptor (400).

### (L) 2 Upper Cylindrical Member (200)

The upper cylindrical member (200) forms the upper portion of the anti-siphon device (100) and serves multiple critical functions including structural support, sealing, and attachment. The upper cylindrical member comprises a sidewall (240) that defines the cylindrical shape and provides the mounting surface for various features.

The sidewall (240) of the upper cylindrical member (200) includes an inner surface (242) and an outer surface (248). The sidewall (240) of the upper cylindrical member (200) defines a hollow interior (210) that extends from an open upper end (220) to an open lower end (230), allowing fuel to pass through during filling operations.

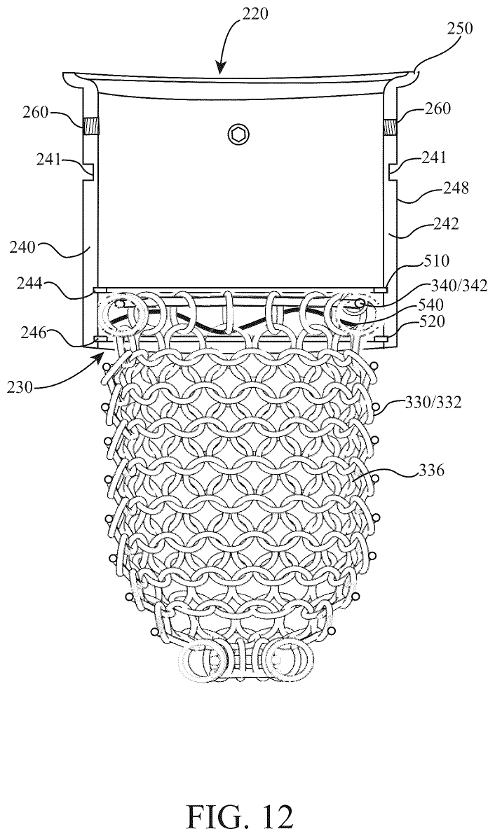

FIG. 12 a cutaway view taken along line 12-12 of FIG. 1 showing the lower cylindrical member (300) inserted into the upper cylindrical member (200) where the sidewall (240) of the upper cylindrical member (200) includes an inner surface (242) and an outer surface (248).

O-ring Annular Groove (241): The outer surface (248) of the sidewall (240) comprises an O-ring annular groove (241). This O-ring annular groove (241) is dimensioned to receive an O-ring (530). The O-ring annular groove (241) typically has a rectangular or trapezoidal cross section with depth and width sufficient to retain the O-ring (530) while allowing slight compression. When the O-ring (530) is positioned within the O-ring annular groove (241), it provides multiple functions: creating a seal to prevent gaps and ensuring that no unprotected areas exist against penetration by a siphoning tube.

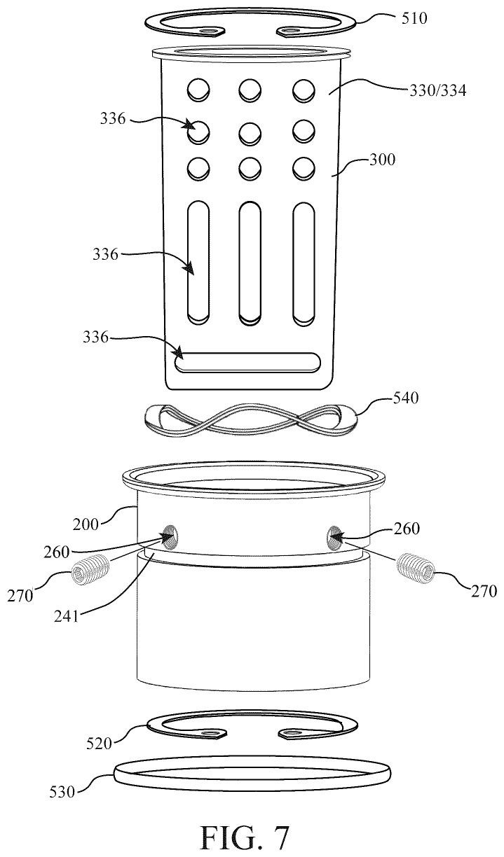

FIG. 12 a cutaway view taken along line 12-12 of FIG. 1 showing the lower cylindrical member (300) inserted into the upper cylindrical member (200) where the sidewall (240) of the upper cylindrical member (200) comprises an O-ring annular groove (241). FIG. 7 is an exploded view of the anti-siphon device (100), showing the upper cylindrical member (200) and the lower cylindrical member (300), where the sidewall (240) of the upper cylindrical member (200) comprises an O-ring annular groove (241).

Upper Annular Groove (244): The inner surface (242) of the sidewall (240) further comprises an upper annular groove (244). This upper annular groove (244) is configured to receive and retain an upper retaining ring (510). The upper annular groove (244) is typically formed as a circumferential recess in the inner surface (242) of the sidewall (240), having a depth and width corresponding to the cross-sectional dimensions of the upper retaining ring (510). The upper annular groove (244) is positioned at a specific location along the longitudinal axis of the upper cylindrical member (200) to create the proper spacing between retaining rings.

Lower Annular Groove (246): The inner surface (242) of the sidewall (240) further comprises a lower annular groove (246) positioned below the upper annular groove (244). The lower annular groove (246) is configured to receive and retain a lower retaining ring (520). Like the upper annular groove (244), the lower annular groove (246) is formed as a circumferential recess with dimensions corresponding to the lower retaining ring's (520) cross-section.

The upper annular groove (244) and lower annular groove (246) are oriented parallel to each other, meaning their planes are substantially perpendicular to the longitudinal axis of the upper cylindrical member (200). The spacing between the upper annular groove (244) and lower annular groove (246) is critical, as this distance determines the gap in which the support segment (340) of the lower cylindrical member (300) will be secured.

FIG. 12 a cutaway view taken along line 12-12 of FIG. 1 showing the lower cylindrical member (300) inserted into the upper cylindrical member (200) where the inner surface (242) of the sidewall (240) of the upper cylindrical member (200) further comprises an upper annular groove (244) and a lower annular groove (246) oriented parallel to each other.

Flange (250): The upper cylindrical member (200) includes a flange (250) that extends outwardly from the sidewall (240). The flange (250) extends substantially perpendicular to the longitudinal axis of the upper cylindrical member (200), creating a radial projection. This flange (250) serves as a mechanical stopper, preventing the anti-siphon device (100) from being pushed too far into the container filler neck (92). The flange (250) also provides a surface for attachment elements in certain embodiments, as will be described later. In one embodiment, the flange (250) of the upper cylindrical member (200) is configured to interface with corresponding features of the custom-fitting neck adaptor (400).

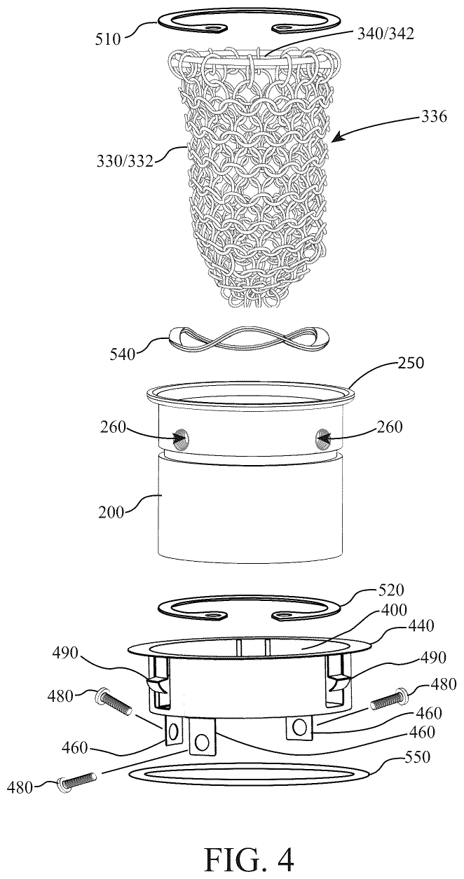

FIG. 4 is an exploded view of the anti-siphon device (100), showing the upper cylindrical member (200) and the lower cylindrical member (300) and utilizing a custom-fitting neck adaptor (400) in a spring-loaded latch attachment embodiment. The upper cylindrical member (200) includes a flange (250) that extends outwardly from the sidewall (240).

Screw Tapped Holes (260): The upper cylindrical member (200) comprises a plurality of screw tapped holes (260). These screw tapped holes (260) extend through the upper cylindrical member (200) into the hollow interior (210). The plurality of screw tapped holes (260) are threaded to receive corresponding set screws (270), which serve to secure the upper cylindrical member (200) to the custom-fitting neck adaptor (400) in certain embodiments. The number of screw tapped holes may vary but typically ranges from two to six holes distributed circumferentially around the upper cylindrical member to provide balanced attachment force.

FIG. 4 is an exploded view of the anti-siphon device (100), showing the upper cylindrical member (200) and the lower cylindrical member (300) and utilizing a custom-fitting neck adaptor (400) in a spring-loaded latch attachment embodiment. The upper cylindrical member (200) comprises a plurality of screw tapped holes (260).

### (L) 3 Lower Cylindrical Member (300)

The lower cylindrical member (300) forms the lower portion of the anti-siphon device (100) and serves as the primary barrier against siphon tube insertion while permitting fluid flow. The lower cylindrical member (300) comprises several key features that work in concert with the upper cylindrical member (200).

Sidewall (330) with Apertures (336): The lower cylindrical member (300) includes a sidewall (330) that comprises a plurality of apertures (336). These apertures (336) permit fluid passage, allowing fuel to flow through the sidewall (330) during filling operations. The apertures (336) are sized to permit liquid fuel flow while preventing insertion of typical siphon tubes. The pattern, size, and spacing of the apertures (336) may vary depending on the specific embodiment and intended application. The apertures (336) may be circular, oval, slotted, or any other shape that permits fluid passage while maintaining structural integrity of the sidewall (330).

Hollow Interior (310) and Open Upper End (320): The sidewall (330) of lower cylindrical member (300) defines a hollow interior (310) accessible through an open upper end (320). The open upper end (320) is dimensioned to interface with the open lower end (230) of the upper cylindrical member (200), creating a continuous fluid pathway through the assembled anti-siphon device (100).

Support Segment (340): A support segment (340) is disposed at the open upper end (320) of the lower cylindrical member (300). The support segment (340) is dimensioned to rest upon the lower retaining ring (520) when the anti-siphon device (100) is assembled. The support segment (340) serves as the attachment point between the lower cylindrical member (300) and the upper cylindrical member (200). The support segment (340) is configured to fit between the upper retaining ring (510) and the lower retaining ring (520), where it is securely held in place.

Chain Mail Construction: In one embodiment, the sidewall (330) of the lower cylindrical member (300) is made from chain mail (332). Chain mail (332) consists of interlocking rings (333) that create a flexible mesh structure with apertures (336) between the interlocking rings (333). This construction provides several advantages: the chain mail (332) is flexible and can conform to irregular surfaces, it is extremely difficult to cut or puncture with typical tools, and it provides excellent fluid passage while blocking siphon tubes. The interlocking rings are made from suitable hardened materials that withstand vandalism forces such as metal or carbon fiber. When the sidewall (330) is constructed from chain mail (332), the support segment (340) comprises a support ring (342) that goes through the chain mail (332) at the open upper end (320). This support ring (342) may be a solid metal ring, a split ring, or any suitable circular element that can be woven through or attached to the upper edge of the chain mail (332) to provide a stable mounting point for engagement with the upper retaining ring (510) and the lower retaining ring (520).

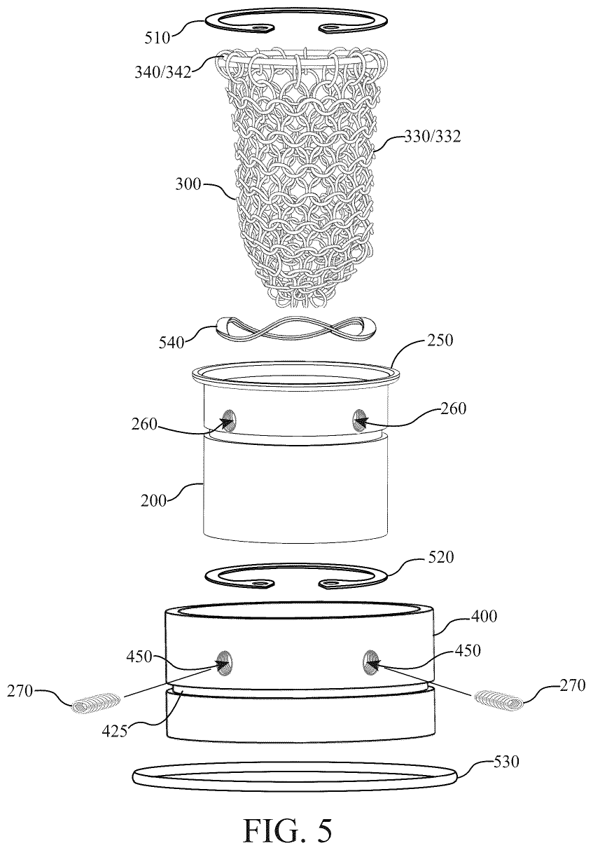

FIG. 5 is an exploded view of the anti-siphon device (100), showing the upper cylindrical member (200) and the lower cylindrical member (300) and utilizing a custom-fitting neck adaptor (400). The sidewall (330) of the lower cylindrical member (300) is made from chain mail (332).

Metal Construction: In alternative embodiments, the sidewall (330) of the lower cylindrical member (300) is made from metal (334) formed into a cylindrical shape with the plurality of apertures (336). The metal (334) may be formed using various manufacturing processes including stamping, machining, or die-casting.

FIG. 7 is an exploded view of the anti-siphon device (100) configured to fit the most popular sized container filler necks (92), showing the upper cylindrical member (200) and the lower cylindrical member (300), where the sidewall (330) of lower cylindrical member (300) is made of metal (334).

In a stamping embodiment, a metal sheet is formed into the cylindrical shape, and the plurality of apertures (336) are created through a stamping or punching process. This manufacturing method allows for precise control over aperture size, pattern, and distribution while providing economical high-volume production.

In a machining embodiment, the lower cylindrical member (300) is formed from a solid metal blank or tube using machining processes such as drilling, milling, or laser cutting to create the plurality of apertures (336). Machining allows for precise dimensional control, complex aperture patterns, and the use of harder metals or alloys that resist tampering.

FIG. 5 is an exploded view of the anti-siphon device (100), showing the upper cylindrical member (200) and the lower cylindrical member (300) and utilizing a custom-fitting neck adaptor (400). The sidewall (330) of the lower cylindrical member (300) is made from chain mail (332). The lower cylindrical member (300) is formed from a solid metal blank or tube using machining processes such as drilling, milling, or laser cutting to create the plurality of apertures (336).

In a die-casting embodiment, molten metal is injected into a mold to form the cylindrical shape with the plurality of apertures (336) formed as part of the casting process. Diecasting enables complex geometries, consistent production of intricate aperture patterns, and integration of the support segment (340) as a single cast piece.

When constructed from metal (334), the support segment (340) comprises a flange (344) that extends outwardly from the sidewall (330) of the lower cylindrical member (300). The flange (344) extends substantially perpendicular to the longitudinal axis of the lower cylindrical member (300), creating a radial projection that can rest securely upon the lower retaining ring (520) and be captured between the upper retaining ring (510) and the lower retaining ring (520).

### (L) 4 Upper Retaining Ring (510) and a Lower Retaining Ring (520)

The anti-siphon device (100) includes an upper retaining ring (510) and a lower retaining ring (520) that work together to secure the lower cylindrical member (300) to the upper cylindrical member (200) while creating an effective barrier against siphon tube insertion.

### (L) 4.1 Upper Retaining Ring (510)

The upper retaining ring (510) is configured to fit within the upper annular groove (244) of the upper cylindrical member (200). The upper retaining ring (510) is typically a circular or toroidal element with a cross-sectional shape corresponding to the upper annular groove (244). When installed in the upper annular groove (244), the upper retaining ring (510) projects inwardly from the hollow interior (210) of the upper cylindrical member (200), creating an upper boundary for the support segment (340) of the lower cylindrical member (300).

### (L) 4.2 Lower Retaining Ring (520)

The lower retaining ring (520) is configured to fit within the lower annular groove (246) of the upper cylindrical member (200). Like the upper retaining ring (510), the lower retaining ring (520) is typically circular or toroidal with a cross-section matching the lower annular groove (246). When installed, the lower retaining ring (520) projects inwardly from the hollow interior (210), creating a lower boundary for the support segment (340) of the lower cylindrical member (300).

### (L) 4.3 Assembly and Function

During assembly, the lower retaining ring (520) is first installed in the lower annular groove (246). The support segment (340) of the lower cylindrical member (300) is then positioned to rest upon the lower retaining ring (520). Finally, the upper retaining ring (510) is installed in the upper annular groove (244), capturing the support segment (340) between the upper retaining ring (510) and a lower retaining ring (520). This configuration secures the lower cylindrical member (300) to the upper cylindrical member (200) while permitting the lower cylindrical member (300) to extend downward into the container. The retaining rings may be made from metal, rigid plastic, or any suitable material providing adequate strength and durability. In some embodiments, the upper retaining ring (510) and a lower retaining ring (520) may be split rings to facilitate installation and removal.

FIG. 12 shows the support segment (340) of the lower cylindrical member (300) placed between the upper retaining ring (510) and the lower retaining ring (520).

### (L) 5 Custom-Fitting Neck Adaptor (400)

To accommodate containers with different filler neck sizes and configurations, certain embodiments include a custom-fitting neck adaptor (400). The custom-fitting neck adaptor (400) provides an interface between the container filler neck (92) and the upper cylindrical member (200) of the anti-siphon device (100).

The custom-fitting neck adaptor (400) comprises a sidewall (420) that defines a hollow interior (410). The sidewall (420) has an upper open end (430) and a lower open end (435). The sidewall may comprise an O-ring annular groove (425).

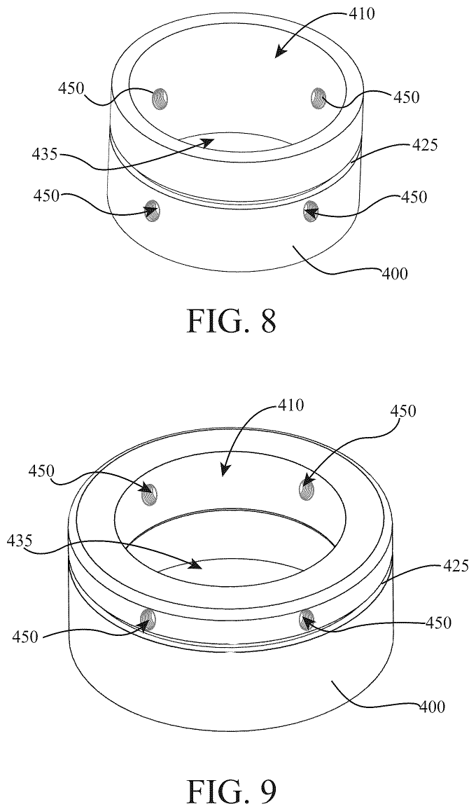

FIG. 8 and FIG. 9 are perspective views of embodiment of the custom-fitting neck adaptor (400).

The custom-fitting neck adaptor (400) is sized to fit within the container filler neck (92), with the outer diameter of the sidewall (420) of the custom-fitting neck adaptor (400) corresponding to the inner diameter of the container filler neck (92). The upper cylindrical member (200) of the anti-siphon device (100) is sized to fit within the custom-fitting neck adaptor (400), with the outer diameter of the upper cylindrical member (200) corresponding to the inner diameter of the hollow interior (410) of custom-fitting neck adaptor (400). This nested configuration allows the system to adapt to various filler neck sizes by using different adaptor sizes while maintaining the same core anti-siphon assembly.

### (L) 5.1 Set Screw Attachment

In one embodiment, the sidewall (420) of the custom-fitting neck adaptor (400) further comprises a plurality of screw tapped holes (450). These screw tapped holes (450) extend through the sidewall (420) into the hollow interior (410), similar to the screw tapped holes (260) in the upper cylindrical member (200) into the hollow interior (210). The custom-fitting neck adaptor (400) further comprises a plurality of set screws (270). The set screws (270) fit within the screw tapped holes (450) of the sidewall (420) of the custom-fitting neck adaptor (400) and the corresponding screw tapped holes (260) of the upper cylindrical member (200); this secures the custom-fitting neck adaptor (400) to the upper cylindrical member (200). When the upper cylindrical member (200) is inserted into the custom-fitting neck adaptor (400), the screw tapped holes (450) of the custom-fitting neck adaptor (400) align with the screw tapped holes (260) of the upper cylindrical member (200). The set screws (270) are then threaded through the aligned holes, securing the two components together and preventing relative rotation or movement.

FIG. 8 and FIG. 9 are perspective views of embodiment of the custom-fitting neck adaptor (400), showing the screw tapped holes (450) extending through the sidewall (420) into the hollow interior (410).

### (L) 5.2 Spring-Loaded Latch Attachment

An alternative embodiment employs a more sophisticated attachment mechanism using spring-loaded latches (490) and vertical attachment tabs (460).

The sidewall (420) of the custom-fitting neck adaptor (400) comprises an outward extending flange (440) that extends outwardly from the sidewall (420). This outward extending flange (440) extends substantially perpendicular to the longitudinal axis of the sidewall (420) of the custom-fitting neck adaptor (400), creating a radial projection. The sidewall (420) maybe cylindrical but other shapes maybe used (e.g. quadrilateral, rectangular). The outward-extending flange (440) outwardly extends from the upper end of the sidewall (420).

FIG. 10 is a perspective view of an embodiment of the custom-fitting neck adaptor (400) in a spring-loaded latch attachment embodiment, where the sidewall (420) comprises a plurality of spring-loaded latches (490).

The sidewall (420) comprises a plurality of spring-loaded latches (490). These spring-loaded latches (490) provide quick-release attachment capability, allowing the custom fitting neck adaptor (400) to be installed and removed without tools. The spring-loaded latches (490) are mounted to the sidewall (420). The spring-loaded latches (490) flex when pressed into the opening of a container filler neck (92) of the container (90) and securely latch when the antisiphon device (100) is fully depressed into the opening of a container filler neck (92).

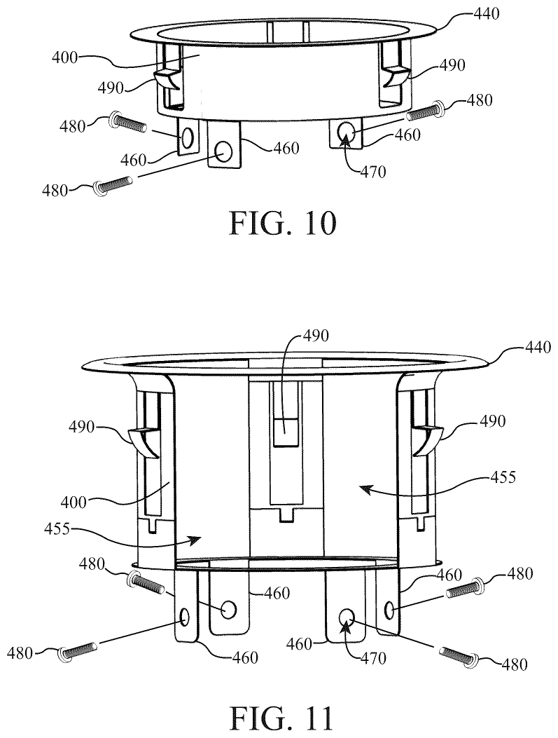

FIG. 11 is a perspective view of an embodiment of the custom-fitting neck adaptor (400) in a spring-loaded latch attachment embodiment, where the sidewall (420) comprises a plurality of spring-loaded latches (490).

The custom-fitting neck adaptor (400) includes a plurality of vertical attachment tabs (460) attached to the lower open end (435) of the sidewall (420). Each vertical attachment tab (460) comprises a corresponding aperture (470). These vertical attachment tabs (460) extend downwardly from the lower end of the sidewall (420) of the custom-fitting neck adaptor (400) and serve as attachment points to the container filler neck (92).

FIG. 11 is a perspective view of an embodiment of the custom-fitting neck adaptor (400) in a spring-loaded latch attachment embodiment, where the sidewall (420) comprises a plurality of spring-loaded latches (490). The custom-fitting neck adaptor (400) includes a plurality of vertical attachment tabs (460) attached to the lower open end (435) of the sidewall (420).

The custom-fitting neck adaptor (400) also includes a plurality of screws (480), where each screw engages with the corresponding aperture (470) in the vertical attachment tabs (460), securing the custom-fitting neck adaptor (400) to the corresponding screw tapped holes (260) of the upper cylindrical member (200).

Additionally, in this embodiment, the custom-fitting neck adaptor (400) further comprises an inward-extending flange (445) that extends inwardly from the sidewall (420), extending substantially perpendicular to the longitudinal axis of the custom-fitting neck adaptor (400). The vertical attachment tabs (460) are attached to the lower open end (435) of the sidewall (420), and the inward-extending flange (445) of the custom-fitting neck adaptor (400) is configured to fit the upper cylindrical member (200), likely by providing a surface against which the upper cylindrical member's outward-extending flange (250) can rest or engage.

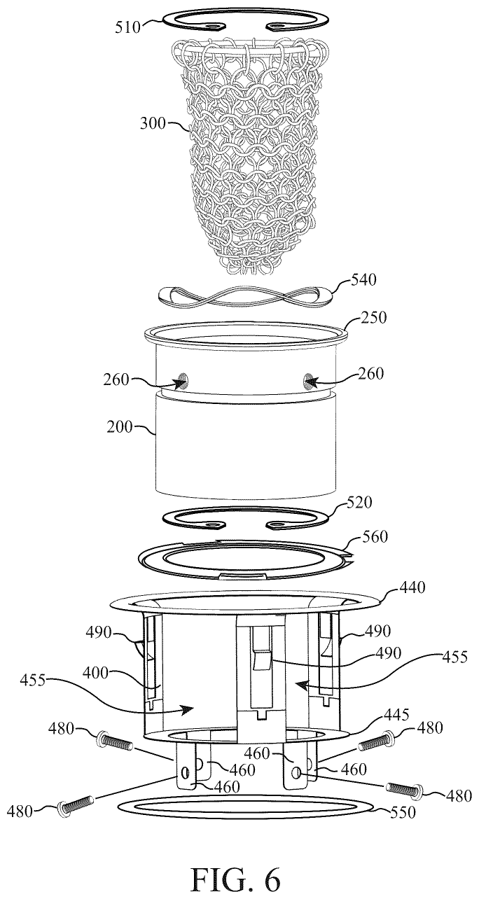

FIG. 6 is an exploded view of the anti-siphon device (100), showing the upper cylindrical member (200) and the lower cylindrical member (300) and utilizing a custom-fitting neck adaptor (400) in a spring-loaded latch attachment embodiment. The custom-fitting neck adaptor (400) further comprises an inward-extending flange (445) that extends inwardly from the sidewall (420).

### (L) 5.3 Slotted Sidewall Attachment

In another embodiment, the sidewall (420) of the custom-fitting neck adaptor (400) comprises a plurality of longitudinal slots (455) or apertures extending from the upper open end (430) toward the lower open end (435) of the sidewall (420). These longitudinal slots (455) are configured to receive corresponding protrusions that extend inwardly from the container filler neck (92). The longitudinal slots (455) extend substantially parallel to the longitudinal axis of the custom-fitting neck adaptor (400), creating channels that guide the custom-fitting neck adaptor (400) during insertion into the container filler neck (92).

FIG. 11 is a perspective view of an embodiment of the custom-fitting neck adaptor (400) in a spring-loaded latch attachment embodiment, where the sidewall (420) comprises a plurality of spring-loaded latches (490) and a plurality of longitudinal slots (455).

The number of longitudinal slots (455) typically ranges from two to eight, distributed circumferentially around the sidewall (420) to provide balanced engagement with the container filler neck protrusions. The width of each longitudinal slot is dimensioned to closely match the width of the corresponding protrusion in the container filler neck (92), creating a tight interference fit that prevents rotation and lateral movement of the custom-fitting neck adaptor (400) within the container filler neck (92).

During installation, the custom-fitting neck adaptor (400) is oriented such that the longitudinal slots (455) align with the protrusions in the container filler neck (92). As the custom-fitting neck adaptor (400) is inserted downward into the container filler neck (92), the protrusions slide into the longitudinal slots (455), creating a keyed connection that ensures proper alignment and prevents rotation. The depth of the longitudinal slots (455) corresponds to the vertical extent of the protrusions, allowing the custom-fitting neck adaptor (400) to be fully seated within the container filler neck (92) when the protrusions reach the bottom of the slots or when the outward-extending flange (440) contacts the top surface of the container filler neck (92).

This slotted sidewall configuration provides several advantages: it allows for tool free installation and removal, creates a secure mechanical lock against rotation and lateral forces, accommodates manufacturing tolerances in both the custom-fitting neck adaptor (400) and the container filler neck (92), and provides positive tactile feedback when the custom-fitting neck adaptor (400) is properly seated. The longitudinal slots may be used in combination with other attachment mechanisms such as set screws (480), spring-loaded latches (490), or the double-sided adhesive element (550) to provide enhanced security and retention force.

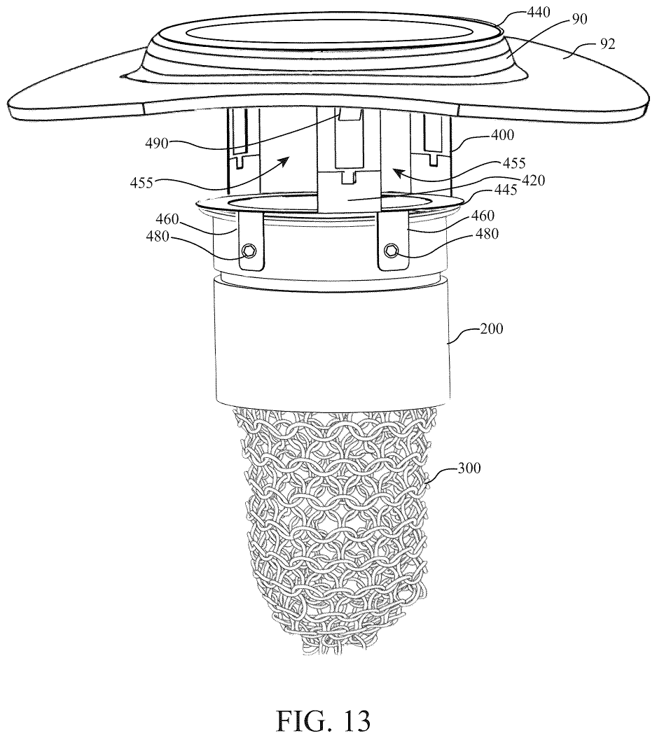

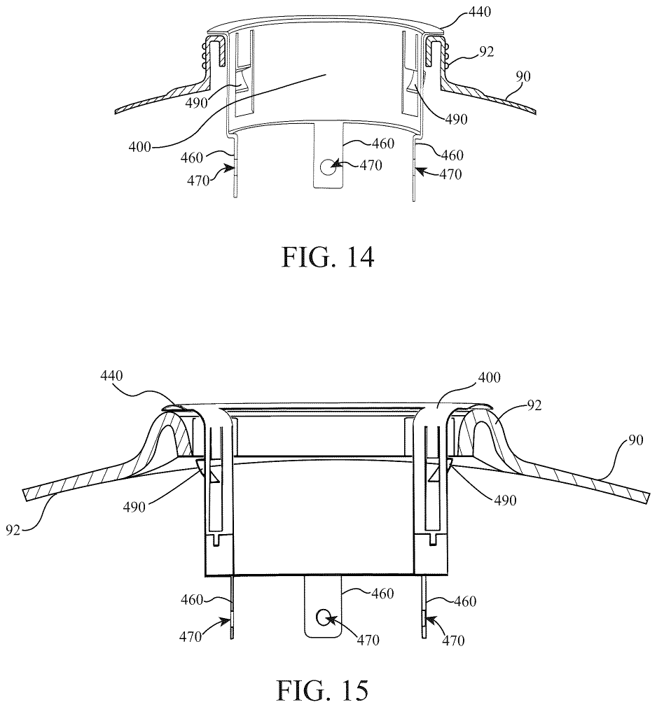

FIG. 13 is a perspective view of an assembled view of the anti-siphon device (100), showing the upper cylindrical member (200) and the lower cylindrical member (300) and utilizing a custom-fitting neck adaptor (400) in a spring-loaded latch attachment embodiment. The anti-siphon device (100) is inserted through the container filler neck (92) of the container. The sidewall (420) of the custom-fitting neck adaptor (400) comprises a plurality of longitudinal slots (455) or apertures extending from the upper open end (430) toward the lower open end (435) of the sidewall (420).

### (L) 6 Additional Features and Enhancements

### (L) 6.1 O-Ring Sealing

The anti-siphon device (100) may further comprise an O-ring (530).

The O-ring (530) may be configured to fit within the O-ring annular groove (241) of the upper cylindrical member (200). The O-ring (530) is positioned within the O-ring annular groove (241) acting as a vibration isolator and stabilizer. The O-ring (530) also prevents any unprotected or open areas against penetration by a siphoning tube by creating a continuous seal around the circumference of the upper cylindrical member (200). This seal ensures that there are no gaps between the upper cylindrical member (200) and the filler neck wall that could be exploited by a thin siphon tube. The O-ring material is selected for compatibility with fuel and lubricants, typically comprising nitrile rubber, fluorocarbon elastomer, or similar chemical-resistant materials.

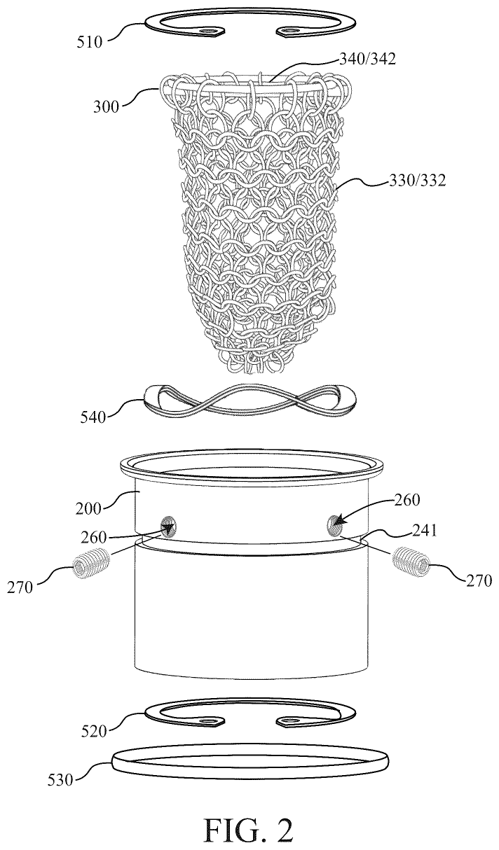

FIG. 2 shows the O-ring (530) configured to fit within the O-ring annular groove (241) of the upper cylindrical member (200).

The O-ring (530) may be configured to fit within the O-ring annular groove (425) of the custom-fitting neck adaptor (400), if the O-ring annular groove (425) is present in the custom-fitting neck adaptor (400). The O-ring (530) is positioned within the O-ring annular groove (425) of the custom-fitting neck adaptor (400) acting as a vibration isolator and stabilizer. The O-ring (530) also prevents any unprotected or open areas against penetration by a siphoning tube by creating a continuous seal around the circumference of the custom-fitting neck adaptor (400). This seal ensures that there are no gaps between the custom-fitting neck adaptor (400) and the filler neck wall that could be exploited by a thin siphon tube. The O-ring material is selected for compatibility with fuel and lubricants, typically comprising nitrile rubber, fluorocarbon elastomer, or similar chemical-resistant materials.

FIG. 2 and FIG. 5 show the O-ring (530) configured to fit within the O-ring annular groove (425) of the custom-fitting neck adaptor (400).

### (L) 6.2 Adhesive Enhancement

Additional security can be provided by a double-sided adhesive element (550). The double-sided adhesive element (550) is positioned under the outward-extending flange (440) of the cylindrical sidewall (420) of the custom-fitting neck adaptor (400). This double-sided adhesive element (550) is configured to increase attachment strength by bonding the outward extending flange (440) to the surrounding surface of the container filler neck (92) or fuel tank. The adhesive provides resistance against attempts to pry or twist the custom-fitting neck adaptor (400) free from the container filler neck (92).

FIG. 4 and FIG. 6 show the double-sided adhesive element (550) is positioned under the outward-extending flange (440) of the cylindrical sidewall (420) of the custom-fitting neck adaptor (400).

In a preferred embodiment, the double-sided adhesive element (550) is chemically resistant, meaning it maintains its adhesive properties when exposed to fuel, oil, and other chemicals commonly found in and around fuel containers. Suitable chemically resistant adhesives include acrylic-based adhesives, epoxy-based adhesives, or specialized fuel-resistant adhesive tapes.

### (L) 6.3 Wave Spring (540)

In an additional embodiment, the anti-siphon device (100) may further comprise a wave spring (540). The wave spring (540) is configured to absorb the shock of hard blows, protecting the anti-siphon device (100) from damage during forceful tampering attempts. The wave spring (540) is placed between the upper retaining ring (510) and the lower retaining ring (520) when they are installed in the upper cylindrical member (200). When installed, the wave spring (540) provides resilient resistance to compressive forces while maintaining the spacing between the upper retaining ring (510) and the lower retaining ring (520) and securing the support segment (340) of the lower cylindrical member (300). The wave spring (540) may be located either over or under the support segment (340) of the lower cylindrical member (300).

FIG. 12 shows the wave spring (540) placed between the upper retaining ring (510) and the lower retaining ring (520). The wave spring (540) is located either under the support segment (340) of the lower cylindrical member (300).

### (L) 6.4 Rubber Damper (560)

In an additional embodiment, the anti-siphon device (100) may further comprise a rubber damper (560). The rubber damper (560) is configured to fill in any space that prevents siphon tube insertion. The rubber damper (560) is placed between the flange (240) of the upper cylindrical member (200) and the inward-extending flange (445) of the sidewall (420) of the custom-fitting neck adaptor (400). The rubber damper (560) has a shore A hardness typically between 40 and 70.

FIG. 6 shows the rubber damper (560) placed between the flange (240) of the upper cylindrical member (200) and the inward-extending flange (445) of the sidewall (420) of the custom-fitting neck adaptor (400).

The rubber damper (560) flexes upwards to allow installation but does not flex downward, thereby preventing the insertion of a siphon tube.

### (L) 7 Operation

Installation: The anti-siphon device (100) is installed by first selecting an appropriately sized custom-fitting neck adaptor (400) if needed for the particular container (90). The custom fitting neck adaptor (400) is inserted into the container filler neck (92) and secured with spring-loaded latches (490), double sided adhesive element (550) or a combination thereof. The upper cylindrical member (200) with the lower retaining ring (520) installed is then inserted into the custom-fitting neck adaptor (400). The support segment (340) of the lower cylindrical member (300) is positioned to rest on a wave spring (540), which lies over the lower retaining ring (520). The upper retaining ring (510) is then installed to capture the support segment (340). Screws (480) or set screws (270) secure the upper cylindrical member (200) to the custom-fitting neck adaptor (400).

FIG. 6 is an exploded view of the anti-siphon device (100), showing the stacking order of the upper cylindrical member (200) and the lower cylindrical member (300) and utilizing a custom-fitting neck adaptor (400). The sidewall (330) of the lower cylindrical member (300) is made from chain mail (332).

Normal Filling Operation: During authorized fuel filling, a fuel nozzle is inserted through the open upper end (220) of the upper cylindrical member (200). Fuel flows downward through the hollow interior (210) of the upper cylindrical member (200), past the upper retaining ring (510), lower retaining ring (520) and support segment (340), through the hollow interior (310) of the lower cylindrical member (300), and through the apertures (336) in the sidewall (330) of the lower cylindrical member (300) into the container (90). The apertures (336) provide sufficient area for unrestricted fuel flow during normal filling operations.

Anti-Siphoning Function: If an unauthorized person attempts to siphon fuel by inserting a tube through the container filler neck (92), the tube encounters the barrier created by the lower cylindrical member (300). The support segment (340) captured between the upper retaining ring (510) and the lower retaining ring (520) prevents the tube from being pushed past the upper cylindrical member (200). The apertures (336) in the sidewall (330) of the lower cylindrical member (300) are too small to permit a siphon tube to pass through, while the overall structure of the lower cylindrical member (300) blocks attempts to insert a tube alongside it. The O-ring (530) prevents gaps that might allow a thin tube to bypass the anti-siphon device (100). In embodiments with chain mail (332) construction, the flexible but impenetrable mesh provides an additional barrier that conforms to and blocks tube insertion. The wave spring (540), if present, absorbs forceful blows without allowing the upper retaining ring (510) and the lower retaining ring (520) to be dislodged.

### (L) 8 Advantages of the Invention

The anti-siphon device (100) provides numerous advantages over prior art fuel theft prevention systems:

The modular design with custom-fitting neck adaptors provides universal compatibility across a wide variety of container types and filler neck sizes without requiring custom manufacturing for each application. This universal adaptability allows the same core anti-siphon assembly to be deployed across different vehicle platforms, fuel container configurations, and industry applications through the use of appropriately sized custom-fitting adaptors.

The dual retaining ring system with captured support segment creates a robust mechanical lock that resists forceful tampering while permitting normal fuel flow.

Multiple attachment options including set screws, spring-loaded latches, and adhesive elements provide flexibility for different installation requirements and security levels.

The O-ring sealing system eliminates bypass opportunities while dampening vibration and movement.

Construction options including chain mail and stamped metal for the lower cylindrical member allow optimization for cost, strength, or specific application requirements.

The wave spring feature provides impact resistance, protecting the device from damage during forceful tampering attempts.

The anti-siphon device (100) permits normal fuel filling operations without restriction while effectively blocking all siphoning attempts.

### (L) 9 Clarifying Comments

While the foregoing written description of the invention enables a person having ordinary skill in the art to make and use what is considered presently to be the best mode thereof, those of ordinary skill in the art will understand and appreciate the existence of variations, combinations, and equivalents of the specific embodiment, process, and examples herein. The invention should therefore not be limited by the above-described embodiment, process, and examples, but by all embodiments and processes within the scope and spirit of the invention.

The inventions shown and described herein may be used to address one or more of such problems or other problems not set out herein and/or which are only understood or appreciated at a later time. The future may also bring to light currently unknown or unrecognized benefits which may be appreciated, or more fully appreciated, in association with the inventions shown and described herein. The desires and expected benefits explained herein are not admissions that others have recognized such prior needs, since invention and discovery are both inventive under the law and may relate to the inventions described herein.

I claim:

1. An anti-siphon device configured to fit and attach to a container's filler neck, the anti-siphon device comprising:
(a) An upper cylindrical member, the upper cylindrical member comprising:
(i) a sidewall, the sidewall comprising:
(1) an outer surface, the outer surface comprising:
(a) an O-ring annular groove;
(2) an inner surface; the inner surface comprising,
(a) an upper annular groove;
(b) a lower annular groove;
(c) where the upper annular groove is oriented parallel to the lower annular groove,
(ii) a hollow interior;
(iii) an open upper end;
(iv) an open lower end;
(v) a flange; where the flange outwardly extending from the sidewall and extending substantially perpendicular to a longitudinal axis of the cylindrical member, and
(vi) a plurality of screw tapped holes; where the screw tapped holes extend through the upper cylindrical member into the hollow interior.
(b) a lower cylindrical member comprising:
(i) a hollow interior;
(ii) an open upper end;
(iii) a sidewall; the sidewall comprising a plurality of apertures that permit fluid passage; and
(iv) a support segment; the support segment disposed at the open upper end of the lower cylindrical member, the support segment dimensioned to rest upon the lower retaining ring,
(c) an upper retaining ring;
(d) a lower retaining ring;
(e) where the upper retaining ring is configured to fit within the upper annular groove;
(f) where the lower retaining ring is configured to fit within the lower annular groove;
(g) where the support segment of the lower cylindrical member is configured to fit between the upper retaining ring and the lower retaining ring.

2. The anti-siphon device from claim 1, the anti-siphon device further comprising:
(a) an O-ring;
(b) where the O-ring annular groove of the upper cylindrical member is configured to receive the O-ring,
(c) where O-ring is position within the O-ring annular groove of the upper cylindrical member so that it prevents any unprotected or open area against penetration by a siphoning
tube.

3. The anti-siphon device from claim 2,
(a) wherein the lower cylindrical member,
(i) the sidewall is made from chain mail; and
(ii) the support segment is a ring that goes through the chain mail.

4. The anti-siphon device from claim 2,
(a) wherein the lower cylindrical member,
(i) the sidewall is made from metal formed by a process selected from the group consisting of stamping, machining, and die-casting;
(ii) the support segment is a flange, where the flange outwardly extending from the sidewall of the lower cylindrical member and extending substantially perpendicular to a longitudinal axis of the lower cylindrical member.

5. The anti-siphon device from claim 2, the anti-siphon device further comprising
(a) a wave spring;
(b) where the wave spring is configured to absorb the shock of hard blows,
(c) where the wave spring is placed between the upper retaining ring and the lower retaining ring of the upper cylindrical member.

6. An enhanced anti-siphon device configured to fit and attach to a container's filler neck, the enhanced anti-siphon device comprising:
(a) An upper cylindrical member; the upper cylindrical member comprising:
(i) a sidewall; the sidewall comprising:
(1) an outer surface; the outer surface comprising: (a) an O-ring annular groove;
(2) an inner surface; the inner surface comprising,
(a) an upper annular groove;
(b) a lower annular groove;
(c) where the upper annular groove is oriented parallel to the lower annular groove,
(ii) a hollow interior;
(iii) an open upper end;
(iv) an open lower end;
(v) a flange; where the flange outwardly extending from the sidewall and extending substantially perpendicular to a longitudinal axis of the cylindrical member, and
(vi) a plurality of screw tapped holes; where the screw tapped holes extend through the upper cylindrical member into the hollow interior.
(b) a lower cylindrical member comprising:
(i) a hollow interior;
(ii) an open upper end;
(iii) a sidewall; the sidewall comprising a plurality of apertures that permit fluid passage; and
(iv) a support segment; the support segment disposed at the open upper end of the lower cylindrical member, the support segment dimensioned to rest upon the lower retaining ring,
(c) an upper retaining ring;
(d) a lower retaining ring;
(e) where the upper retaining ring is configured to fit within the upper annular groove,
(f) where the lower retaining ring is configured to fit within the lower annular groove,
(g) where the support segment of the lower cylindrical member is configured to fit between the upper retaining ring and the lower retaining ring.
(h) a custom-fitting neck adaptor; the custom-fitting neck adaptor comprising:
(i) a sidewall; the sidewall comprising:
(1) an upper end;
(2) a lower end;
(ii) a hollow interior;
(i) where the custom-fitting neck adaptor is sized to fit within the container filler neck,
(j) where the upper cylindrical member is sized to fit within the custom-fitting neck adaptor.

7. The enhanced anti-siphon device from claim 6,
(a) wherein the sidewall of the custom-fitting neck adaptor further comprises:
(i) a plurality of screw tapped holes; where the screw tapped holes extend through the sidewall of the custom-fitting neck adaptor into the hollow interior of the custom-fitting neck adaptor,
(ii) an outer surface; the outer surface comprising:
(1) an O-ring annular groove;
(b) wherein the custom-fitting neck adaptor further comprises:
(i) a plurality of set screws; where the plurality of set screws fit within the corresponding plurality of screw tapped holes of the custom-fitting neck adaptor and the upper cylindrical member

8. The enhanced anti-siphon device from claim 7, the enhanced anti-siphon device further comprising:
(a) an O-ring;
(b) where the O-ring annular groove of the custom-fitting neck adaptor is configured to receive the O-ring;
(c) where the O-ring is positioned within the O-ring annular groove of the custom-fitting neck adaptor so that the O-ring prevents any unprotected or open area against penetration by a siphoning tube.

9. The enhanced anti-siphon device from claim 6,
(a) wherein the sidewall of the custom-fitting neck adaptor further comprises
(i) an outward-extending flange, where the outward-extending flange outwardly extending from the sidewall and extending substantially perpendicular to a longitudinal axis of the sidewall of custom-fitting neck adaptor.
(ii) where the outward-extending flange outwardly extends from the upper end of the sidewall (420),
(iii) a plurality of spring-loaded latches;
(b) where the custom-fitting neck adaptor further comprises
(i) a plurality of vertical attachment tabs; each vertical attachment tab comprising:
(1) an aperture;
(ii) a plurality of screws;
(iii) an inward-extending flange; where the inward-extending flange inwardly extending from the sidewall and extending substantially perpendicular to a longitudinal axis of the custom-fitting neck adaptor,
(iv) where the vertical attachment tabs are attached to the lower end of the sidewall of the custom-fitting neck adaptor,
(v) where the outward-extending flange of the custom-fitting neck adaptor is configured to fit the upper cylindrical member,
(vi) where the plurality of screws engages with the corresponding apertures in the vertical attachment tabs, securing the custom-fitting neck adaptor to the corresponding screw tapped holes of the upper cylindrical member.

10. The enhanced anti-siphon device from claim 9,
(a) wherein the sidewall of the custom-fitting neck adaptor further comprises:
(i) a plurality of longitudinal slots; the plurality of longitudinal slots extending from the upper open end toward the lower open end of the sidewall, where the longitudinal slots extend substantially parallel to a longitudinal axis of the custom-fitting filler neck adaptor,
(b) wherein the longitudinal slots are configured to receive corresponding protrusions extending inwardly from the container filler neck,
(c) wherein the longitudinal slots are dimensioned to create a tight interference fit with the
protrusions to prevent rotation and lateral movement of the custom-fitting neck adaptor within the container filler neck.

11. The enhanced anti-siphon device from claim 9,
(a) wherein the lower cylindrical member,
(i) the sidewall is made from chain mail; and
(ii) the support segment is a ring that goes through the chain mail.

12. The enhanced anti-siphon device from claim 9,
(a) wherein the lower cylindrical member,
(i) the sidewall is made from metal formed by a process selected from the group consisting of stamping, machining, and die-casting;
(ii) the support segment is a flange; where the flange outwardly extending from the sidewall of the lower cylindrical member and extending substantially perpendicular to a longitudinal axis of the lower cylindrical member.

13. The enhanced anti-siphon device from claim 9, the enhanced anti-siphon device further comprising
(a) a double-sided adhesive element;
(b) where the double-sided adhesive element is positioned under the outward-extending flange of the sidewall of the custom-fitting neck adaptor,
(c) where the double-sided adhesive element is configured to increase attachment strength.

14. The enhanced anti-siphon device from claim 13,
(a) where the double-sided adhesive element is chemically resistant.

15. The enhanced anti-siphon device from claim 9, the enhanced anti-siphon device further comprising
(a) a wave spring;
(b) where the wave spring is configured to absorb the shock of hard blows,
(c) where the wave spring is placed between the upper retaining ring and the lower retaining ring of the upper cylindrical member.

16. The enhanced anti-siphon device from claim 9, the enhanced anti-siphon device further comprising
(a) a rubber damper;
(b) where the rubber damper is configured to prevent siphon tube insertion,
(c) where the rubber damper is placed between the flange of the upper cylindrical member and the inward-extending flange of the sidewall of the custom-fitting neck adaptor.
